(19) United States
(12) Patent Application Publication
(10) Pub. No.: US 2008/0098383 A1
(43) Pub. Date: Apr. 24, 2008

(54) METHOD FOR INSTALLING A NEW VERSION OF A HEARING-DEVICE FITTING-SOFTWARE PACKAGE ON A COMPUTER SYSTEM

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 11/551,254

(22) Filed: Oct. 20, 2006

(51) Int. Cl. G06F 9/44

(52) U.S. Cl. 717/170

(57) ABSTRACT

The method for installing a new version (30) of a hearing-device fitting-software package on a computer system (1), comprises the steps of
a) providing an old installation-software package (200), which is an installation software-package for installing an old version of said hearing-device fitting-software package;
b) providing a delta-update package (3200), which is a software package for creating an updated installation-software package (300) out of said old installation-software package (200), wherein said updated installation-software package (300) is an installation software-package for installing said new version (30) of said hearing-device fitting-software package;
c) using said delta-update package (3200) for creating said updated installation-software package (300) out of said old installation-software package (200);
d) using said updated installation-software package (300) for installing said new version (30) of said hearing-device fitting-software package on said computer system (1).

This way of software updating needs only a small amount of data and can minimize certification efforts, since the software installation always starts from the same preconditions.

### TECHNICAL FIELD

The invention relates to methods and computer program products for installing a new version of a hearing-device fitting-software package on a computer system. Hearing-device fitting-software is used by hearing device professionals for adjusting hearing devices.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

A hearing-device fitting-software package is typically deployed by deploying a number of CD-ROMs on which an installation-software package is stored, or by downloading an equivalent installation-software package from the internet.

When a new version of the hearing-device fitting-software package is issued, also referred to as updated version of said hearing-device fitting-software package, this can be deployed in the same way as described above. This allows to provide for a full installation of the hearing-device fitting-software package, i.e., for an installation that does not make use of on an old version of the hearing-device fitting-software package possibly still installed. But in case of deployment via CD-ROMS, one or more CD-ROMs have to be manufactured and must be physically sent to interested hearing device professionals. And in case of downloading from the internet, a large amount of data, typically several hundreds of megabytes, has to be downloaded from the internet.

In order to minimize the amount of data to be transferred to a hearing device professional for updating a hearing-device fitting-software package, it would be possible to distribute in the installation-software package basically only those files of the hearing-device fitting-software package, which have changed between the previous and the new version of the hearing-device fitting-software package. These new files could then be merged with an existing installation of the hearing-device fitting-software package, so as to derive the desired updated version of said hearing-device fitting-software package.

Hearing-device fitting-software packages typically undergo a certification process by the Hearing Instruments Manufacturers' Software Association (HIMSA), which verifies that a software product is operational, adheres to certain standards, and does not interfere with other hearing-device fitting-software packages installed on the same computer system. In addition, hearing-device fitting-software packages typically undergo extensive testing at the manufacturer's place to ensure that it works as specified, and that it is compatible with new and older hearing devices.

Any new version of a hearing-device fitting-software package will usually be certified/tested for the above-described reasons. This is usually done by installing the new version from one or more CD-ROMs, on which the installation-software package for the full installation of this new version is stored, on a computer system. The underlying assumption for this way of proceeding is, that the data on the CD-ROM(s) completely determine the set and arrangement of files that will be stored in a user's computer system, and that an installation from such a CD-ROM (or CD-ROMs) onto a tester's computer system will result in the same installed configuration as an installation from the same CD-ROM (or CD-ROMs) onto a user's computer system.

When also the possibility for updating older versions of the hearing-device fitting-software package to the newest version shall be provided, it is necessary to certify/test each and every of the different installation-software packages, which have to be deployed. E.g., when it shall be possible to update from previous versions 1, 2 and 3 to new version 4, it would be necessary to issue an installation-software package for installing version 4 from version 1 for installing version 4 on a computer system on which version 1 has been pre-installed, and to issue an installation-software package for installing version 4 from version 2 for installing version 4 on a computer system on which version 2 has been pre-installed, and to issue an installation-software package for installing version 4 from version 3 for installing version 4 on a computer system on which version 3 has been pre-installed. Each of these three version-4-installations would have to be tested/verified, of course, in addition to testing/verifying a full installation of version 4.

As can be seen easily, the testing/certifying efforts are enormous, in particular considering how fast hearing device technology develops, resulting in new hearing-device fitting-software package features and in new hearing device models, and, accordingly, in new versions of hearing-device fitting-software packages.

However, minimizing the testing/certifying efforts by abandoning the possibility of updates based on older versions, would require the physical distribution of data carriers like CD-ROMs or the download of large amounts of data, allowing for a full installation, as has been sketched above.

It is desirable to provide for an alternative way for installing a new version of a hearing-device fitting-software package on a computer system.

### SUMMARY OF THE INVENTION

Therefore, one object of the invention is to create a way for installing a new version of a hearing-device fitting-software package on a computer system that does not have the disadvantages mentioned above. In particular, a transmission of a relatively small amount of data shall be sufficient for installing a new version of the hearing-device fitting-software package, and efforts for certifying a new version of the hearing-device fitting-software package shall preferably be minimized.

A method for installing a new version of a hearing-device fitting-software package on a computer system, a method for manufacturing a software package for installing a new version of a hearing-device fitting-software package on a computer system, and a method for manufacturing an installation of a new version of a hearing-device fitting-software package on a computer system shall be provided, which provide for an alternative way of installing a new version of a hearing-device fitting-software package on a computer system. In addition, a corresponding computer program product and a corresponding computer-readable storage medium shall be provided.

Further objects of the invention emerge from the description and embodiments below.

At least one of the objects is at least partially achieved by apparatuses or methods according to the patent claims.

The method for installing a new version of a hearing-device fitting-software package on a computer system comprises the steps of
a) providing an old installation-software package, which is an installation software-package for installing an old version of said hearing-device fitting-software package;
b) providing a delta-update package, which is a software package for creating an updated installation-software package out of said old installation-software package, wherein said updated installation-software package is an installation software-package for installing said new version of said hearing-device fitting-software package;
c) using said delta-update package for creating said updated installation-software package out of said old installation-software package;
d) using said updated installation-software package for installing said new version of said hearing-device fitting-software package on said computer system.

Accordingly, it will usually be possible to generate an updated version of a hearing-device fitting-software package without the need to transfer a large amount of data when said new version of the hearing-device fitting-software package is issued. Usually, only a small amount of data will have to be transmitted. Nevertheless, the actual installation of the new version will always be done using one well-defined installation-software package, which can greatly reduce certification and testing efforts.

Considered under a slightly different point of view, the invention suggests to update the installation-software package in order to generate an updated installation-software package, by means of which the desired hearing-device fitting-software package can then be installed. In contrast, a commonly known method for software updating involves direct updating of the application software in question, which usually will also need the deployment of only small amounts of data. But the certification and testing of such updating software and of correspondingly-installed software packages is cumbersome or not even possible.

In one embodiment, the method comprises the step of
e) deleting an old version of said hearing-device fitting-software package stored in said computer system.

Step e) is preferably performed before step d).

In one embodiment, the method comprises the step of
f) receiving said delta-update package via the internet.

This can be advantageous, because it allows to distribute the newly-generated data needed for installing said new version very quickly. Accordingly, bug fixes can be quickly distributed, and the introduction of new hearing devices does not have to be delayed due to problems in physically distributing a correspondingly-updated hearing-device fitting-software package. Furthermore, there is no need to produce and distribute a large amount of data carriers (at least one for each hearing device professional involved), which results in considerable time and money savings.

In one embodiment, the method comprises the steps of
g) obtaining verification data from said updated installation-software package; and
h) validating said updated installation-software package by verifying said verification data.

This way, it can be proved that the installation-software package created in step c) has been obtained correctly and is perfectly in order. The steps g) and h) are preferably performed before step d).

Said verification data may, e.g., comprise or be a checksum. Any of the many ways of such verifications known in the field of software programming can be applied, e.g., the so-called MD5 checksum. This allows to check—to a high degree of certainty—whether or not said updated installation-software package created in step c) is bit-wise identical with an original full installation-software package generated by the manufacturer.

For example, verification data, e.g., an MD5 checksum generated by the manufacturer is provided with the delta-update package, and after creating said updated installation-software package, the MD5 checksum of this newly-created updated installation-software package is calculated and compared with the manufacturer-provided MD5 checksum. If the two checksums are identical, it can be assumed—with a practically negligible error probability—that the creation of the updated installation-software package was successful, and it can, accordingly, be assumed that a new version of a hearing-device fitting-software package installed by means of said newly-created updated installation-software package will be identical with a hearing-device fitting-software package obtained elsewhere, and in particular with a hearing-device fitting-software package that has been tested by the manufacturer and has undergone certifications, like the HIMSA certification.

In one embodiment, said new version of a hearing-device fitting-software package is a HIMSA-certified software package, wherein HIMSA stands for Hearing Instruments Manufacturers' Software Association.

In one embodiment, the method comprises the step of
j) creating a backup copy of said updated installation-software package for use during a future installation of a newer version of said hearing-device fitting-software package.

As can be seen in step a), the invention requires that a copy of an old installation-software package is available. In step j), such a copy is made. This backup copy can, e.g., be stored on a read-write data carrier, e.g., a hard disk, in which case it will preferably be write-protected afterwards in order to avoid corruption, or on write-once data carriers like suitable CDs or DVDS.

In one embodiment, the method comprises the step of
i) reading said old installation-software package from a read-only or write-protected storage medium.

This read-only or write-protected storage medium can, e.g., be one that was formerly used for creating a backup copy in an action corresponding to step j), or a storage medium provided by the manufacturer, e.g., a CD-ROM or DVD-ROM.

In one embodiment, said delta-update package comprises a new version of such documents to be comprised within said updated installation-software package, which were not comprised in said old installation-software package or are different in said updated installation-software package with respect to corresponding documents comprised in said old installation-software package. These data can preferably be accompanied with data indicating the destination directory of the files relative to the directory root of the updated installation-software package. In this embodiment, a relatively simple script managing the installation, also referred to as installation script, may be used, but the amount of data that have to be comprised in the delta-update package is not minimized.

In another embodiment, said delta-update package comprises data representing instructions for creating said updated installation-software package from said old installation-software package by deleting portions of said old installation-software package and/or replacing portions of said old installation-software package by replacement items and/or inserting insertion items. Preferably, said delta-update package additionally comprises corresponding replacement items and insertion items; such items may be single bytes, larger portions of program code, subroutines or complete program components. In this embodiment, only a very reduced amount of data has to be comprised in the delta-update package. But the installation script will be more complicated than in the above-described embodiment.

For creating such a delta-update package, in particular if replacement items and/or insertion items of very small size shall be included, it is advisable to determine the difference between the old and the updated installation-software package on a binary level. This binary-level information can be created and formatted in any manner known in the field of software programming, e.g., in a way described in U.S. Pat. No. 6,738,799, or by means of tools like the Unix command line tools diff and sdiff may be employed (see, e.g., http://www.gnu.org/software/diffutils/diffutils.html). This allows to generate very storage-efficient delta-update packages.

The above-described methods for installing a new version of a hearing-device fitting-software package on a computer system can also be considered methods for manufacturing an installation of a new version of a hearing-device fitting-software package on a computer system.

The method for manufacturing a software package for installing a new version of a hearing-device fitting-software package on a computer system comprises, according to the invention, the step of
k) creating—for at least one of N older versions of said hearing-device fitting-software package, with N≧1—a delta-update package, which is a software package for creating an updated installation-software package out of an old installation-software package, which old installation-software package is an installation software-package for installing said old version of said hearing-device fitting-software package, and wherein said updated installation-software package is an installation software-package for installing said new version of said hearing-device fitting-software package.

According to the invention, the computer program product comprises program code for causing a computer to perform the step of
c′) creating an updated installation-software package out of an old installation-software package, which old installation-software package is an installation software-package for installing said old version of a hearing-device fitting-software package, and wherein said updated installation-software package is an installation software-package for installing said new version of said hearing-device fitting-software package

In one embodiment of the computer program product, said program code is adapted to causing said computer to perform in addition the step of
d′) using said updated installation-software package for installing said new version of said hearing-device fitting-software package on a computer system.

According to the invention, the computer-readable storage medium comprising program code for causing a computer to perform the step of
c′) creating an updated installation-software package out of an old installation-software package, which old installation-software package is an installation software-package for installing said old version of a hearing-device fitting-software package, and wherein said updated installation-software package is an installation software-package for installing said new version of said hearing-device fitting-software package.

In one embodiment of the computer-readable storage medium, said program code is adapted to causing said computer to perform in addition the step of
d′) using said updated installation-software package for installing said new version of said hearing-device fitting-software package on a computer system.

Examples for computer-readable storage media are floppy disks, hard disks, CDs, DVDS, memory chips, memory sticks.

The advantages of the methods correspond to the advantages of corresponding apparatuses and vice versa.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a block diagram illustrating a method and a computer program product according to the invention;

FIG. 2 a block diagram illustrating installation-software packages involved in the invention;

FIG. 3 a block diagram illustrating a method according to the invention.

The reference symbols used in the figures and their meaning are summarized in the list of reference symbols. The described embodiments are meant as examples and shall not confine the invention.

### DETAILED DESCRIPTION OF THE INVENTION

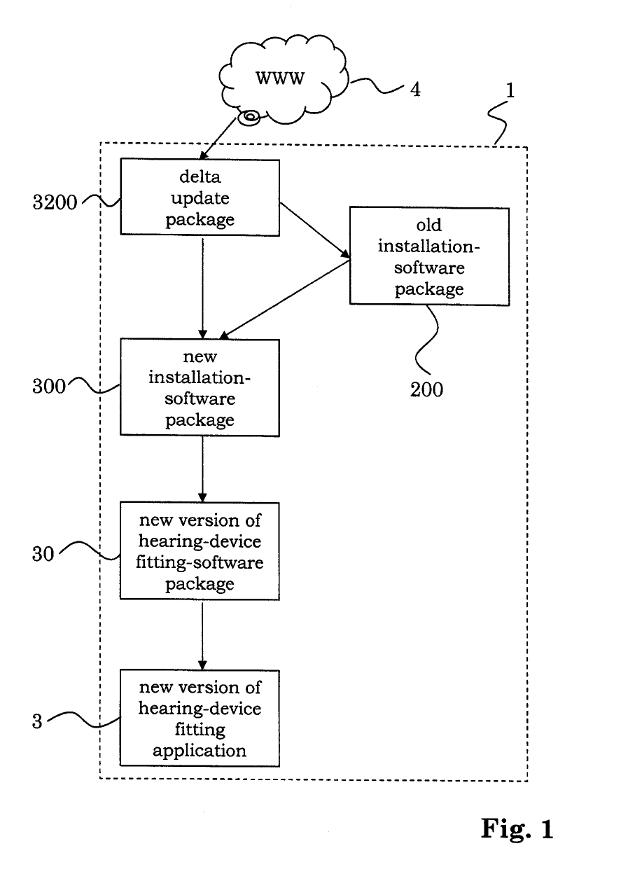

FIG. 1 shows a block diagram illustrating a method and a computer program product according to the invention as performed on a computer system 1. Standard parts of a computer system 1 like input units like keyboards, output units like displays and printers, processors, memories, storage devices are not shown in FIG. 1.

Via the internet 4 (WWW), a delta-update package 3200 is received. Making use of this delta-update package 3200 and an old installation-software package 200, a new installation-software package 300 is obtained. By means of this new installation-software package 300, a new version 30 of a hearing-device fitting-software package is installed on a computer system. This new version 30 of a hearing-device fitting-software package allows to let a hearing-device fitting application 3 run on said computer system, which can be used by a hearing device professional for adjusting hearing devices.

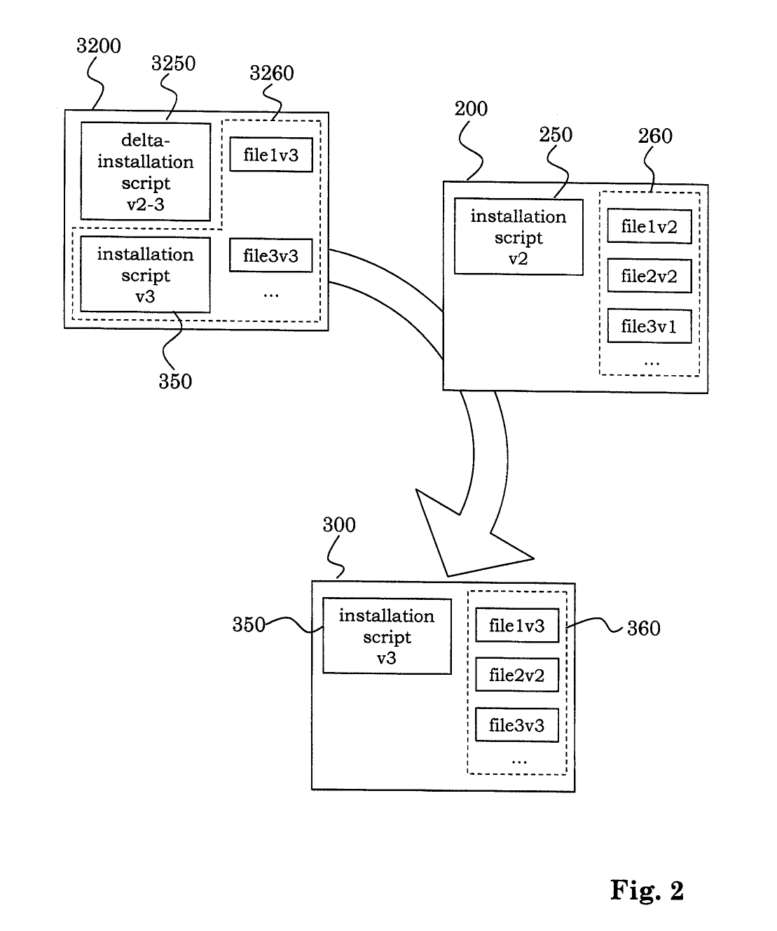

FIG. 2 provides for more detail than FIG. 1 and shows a block diagram illustrating installation-software packages involved in the invention. In this example, it is assumed, that an old installation-software package 200 exists, by means of which an old version (version 2) of a hearing-device fitting-software package can be installed on a computer system. By means of a delta-update package 3200, an updated installation-software package 300 shall be obtained on the basis of said old installation-software package 200, wherein a desired version 30 of said hearing-device fitting-software package can be installed by means of said updated installation-software package 300.

Said old installation-software package 200 comprises an executable file 250, which is an installation script suitable for installing said old version of the hearing-device fitting-software package, and further data 260, which are used during an installation of said old version of the hearing-device fitting-software package, most of them usually non-executable files. These further data 260 will typically comprise, among others, a file representing version 2 of the hearing-device fitting application, and files related to a multitude of hearing devices, which can be adjusted by means of said version 2 of the hearing-device fitting application, and files used during the installation, e.g., copyright notes and screen images. Said further data 260 may as well comprise files from which the before-mentioned files can be obtained, e.g., by extracting compressed files.

In order to be able to generate said updated installation-software package 300 from said old installation-software package 200, the delta-update package 3200 comprises all those data to be comprised in said updated installation-software package 300, which are not comprised in said old installation-software package 200. This can be accomplished in a storage-minimizing way by providing—in addition to all files that are to be comprised in said updated installation-software package 300 and not comprised in said old installation-software package 200—information on the differences between similar files in the two versions of the installation-software package, or—as depicted in FIG. 2—by providing all files 3260 that are comprised in said updated installation-software package 300 and not comprised in said old installation-software package 200 in addition to all files that changed from said old installation-software package 200 to said updated installation-software package 300, or in a mixture of these two ways.

In addition, the delta-update package 3200 comprises an executable file 3250, which is an installation script suitable for managing the described updating of said old installation-software package 200 to said updated installation-software package 300. Controlled by the delta-update package 3200, said updated installation-software package 300 will be generated, which comprises an executable file 350 and further data 360. Preferably, the installation script 3250 will also start—after the creation of said updated installation-software package 300—the installation of the desired updated version (version 3) of the hearing-device fitting-software package (cf. FIG. 1). The updated installation-software package 300 is usually composed similarly to the old installation-software package and comprises, accordingly, an executable file 350, which is an installation script suitable for installing said new version of the hearing-device fitting-software package, and further data 360, which are used during an installation of said new version of the hearing-device fitting-software package, most of them usually non-executable files.

Instead of providing the executable file 3250 in the delta-update package 3200, it is also possible to have such an executable file included in the old installation-software package 200, in which case the delta-update package is preferably structured such that such an executable file can also be used for at least one future installation process.

As indicated in FIG. 1, it is possible to perform the updating of the installation-software package on the same computer system 1 as the installation of the hearing-device fitting-software package. It is also possible to use a separate computer system for creating the updated installation-software package 300.

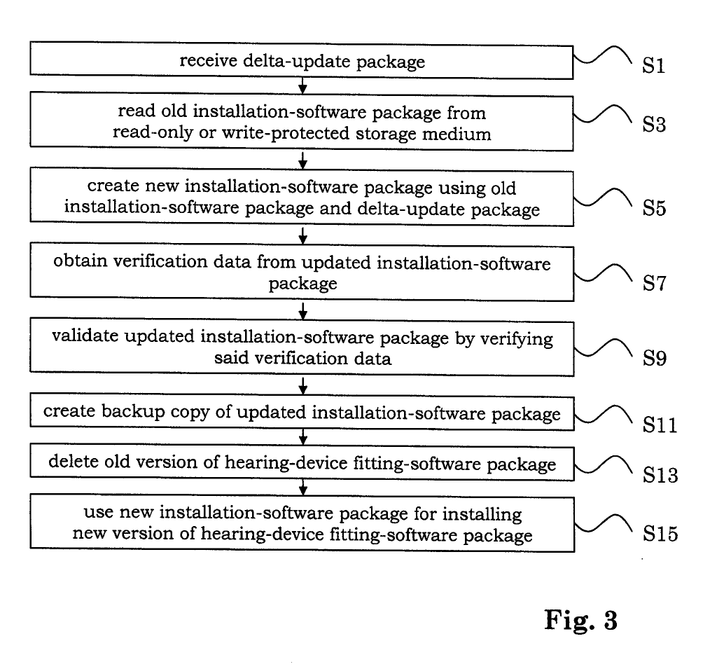

A great advantage of the invention is due to the fact that hearing-device fitting-software packages usually have to be certified, in particular by the HIMSA, and undergo extensive testing. By means of the invention, it is possible to install a new version 30 of a hearing-device fitting-software package on a computer system 1 without transmitting great amounts of data (since the delta-update package 3200 will usually be small as compared to the updated installation-software package 300), while nevertheless, a full installation is performed, i.e., the installation does not make use of an old version of the hearing-device fitting-software package possibly still installed in the computer system 1 (cf. FIG. 1). A full installation has the advantage that it can be done regardless of the existence or status (completeness, possible corruption) of previous versions. Accordingly, testing and certification can be done based on only one type of installation, namely based on a full installation. It only should be assured that the installation-software package used for the installation is valid, i.e., that the updated installation-software package 300 created according to the invention is not different from the installation-software package used during testing and certification. Details on such a validation are given below in conjunction with steps S7, S9 of FIG. 3.

The invention requires only a small amount of new data, i.e., data obtained after the last installation, and can minimize certification efforts, since the installation always starts from the same preconditions (full installation).

FIG. 3 shows another block diagram illustrating a method according to the invention, which comprises several preferred steps. The sequence in which the steps are shown in FIG. 3 is only one of several possible sequences. In step S1, a delta-update package is received. The delta-update package can be received in one or several portions. Each portion can be received, e.g., via the internet, from another network, stored in a storage medium, e.g., stored in a CD or a memory stick, or stored in a storage unit inside a hearing device. In the latter case, storage units of (preferably new) hearing devices, which are shipped to a hearing device professional, can be loaded with data of the delta-update package. This way of deploying data may be accomplished, e.g., in a way as described in EP 1 473 969 A2.

In step S3, the old installation-software package is read, at least in part, and preferably from a read-only or a write-protected storage medium, because if changes could and would be applied to the old installation-software package before it is updated, failures of the update are likely to occur. In step S5, the delta-update package and the old installation-software package are used for creating a new installation-software package. In fact, step S3 will typically be accomplished during step S5.

In step S7, verification data are obtained from the new installation-software package created in step S5. This can be accomplished, e.g., by calculating a checksum of the updated installation-software package. In step S9, the updated installation-software package is validated by verifying said verification data. This will usually be accomplished by comparing said verification data with verification data obtained from the manufacturer of the delta-update package, typically contained in the delta-update package. If the validation fails, i.e., the verification data indicate that the created updated installation-software package is not as it should be (apparently no bit-wise identity), an error will be reported. In case of a successful validation, it will be continued.

In step 11, a backup copy of the updated installation-software package is created, e.g., on a hard disk of the computer system, preferably write-protected, or on another storage medium, preferably also write-protected or on a write-once storage medium, e.g., a suitable CD or DVD. This backup copy can be used as an old installation software package when another new version of the hearing-device fitting-software package and a corresponding new delta-update package have been issued.

In optional step S13, any old versions of the hearing-device fitting-software package are deleted from the storage medium of the computer system on which the new version of the hearing-device fitting-software package shall be installed. This shall avoid problems during the installation depicted in step S15. Alternatively, paths and directories belonging to the old version of the hearing-device fitting-software package can be renamed. A further alternative is to overwrite the old version of the hearing-device fitting-software package by the new version of the hearing-device fitting-software package. This can allow to preserve data and preferences input by the hearing device professional.

In step S15, the updated installation-software package created in step S5 is used for installing the desired new version of the hearing-device fitting-software package in the computer system.

A manufacturer can provide for several different delta-update packages when issuing one new version of hearing-device fitting-software package, each of them for an update of a different old installation-software package to the same new installation-software package by means of which said new version of hearing-device fitting-software package can be installed.

A system for installing a new version 30 of a hearing-device fitting-software package on a computer system 1 can be considered to be a part of the invention, which system comprises at least one delta-update package 3200, which is a software package for creating an updated installation-software package 300 out of an old installation-software package 200, which old installation-software package 200 is an installation software-package for installing said old version of said hearing-device fitting-software package, and wherein said updated installation-software package 300 is an installation software-package (cf. FIG. 1).

### LIST OF REFERENCE SYMBOLS

1 computer system
3 new version of hearing-device fitting application
4 internet
30 new version of hearing-device fitting-software package
200 old installation-software package
250 executable file, old installation script
260 data, files
300 updated installation-software package
350 executable file, new installation script
360 data, files
3200 delta-update package
3250 executable file, delta-installation script
3260 data, files
S1, . . . , S15 steps

1. Method for installing a new version of a hearing-device fitting-software package on a computer system, comprising the steps of
a) providing an old installation-software package, which is an installation software-package for installing an old version of said hearing-device fitting-software package;
b) providing a delta-update package, which is a software package for creating an updated installation-software package out of said old installation-software package, wherein said updated installation-software package is an installation software-package for installing said new version of said hearing-device fitting-software package;
c) using said delta-update package for creating said updated installation-software package out of said old installation-software package;
d) using said updated installation-software package for installing said new version of said hearing-device fitting-software package on said computer system.

2. The method according to claim 1, comprising the step of
e) deleting an old version of said hearing-device fitting-software package stored in said computer system.

3. The method according to claim 1, comprising the step of
f) receiving said delta-update package via the internet.

4. The method according to claim 1, comprising the steps of
g) obtaining verification data from said updated installation-software package; and
h) validating said updated installation-software package by verifying said verification data.

5. The method according to claim 1, comprising the steps of
i) reading said old installation-software package from a read-only or write-protected storage medium.

6. The method according to claim 1, comprising the step of
j) creating a backup copy of said updated installation-software package for use during a future installation of a newer version of said hearing-device fitting-software package.

7. The method according to claim 1, wherein said new version of a hearing-device fitting-software package is a HIMSA-certified software package, wherein HIMSA stands for Hearing Instruments Manufacturers' Software Association.

8. The method according to claim 1, wherein said delta-update package comprises a new version of such documents comprised within said updated installation-software package, which were not comprised in said old installation-software package or are different in said updated installation-software package with respect to corresponding documents comprised in said old installation-software package.

9. The method according to claim 1, wherein said delta-update package comprises
data representing instructions for creating said updated installation-software package from said old installation-software package by deleting portions of said old installation-software package and/or replacing portions of said old installation-software package by replacement items and/or inserting insertion items.

10. Method for manufacturing an installation of a new version of a hearing-device fitting-software package on a computer system, comprising the steps of
a) providing an old installation-software package, which is an installation software-package for installing an old version of said hearing-device fitting-software package;
b) providing a delta-update package, which is a software package for creating an updated installation-software package out of said old installation-software package, wherein said updated installation-software package is an installation software-package for installing said new version of said hearing-device fitting-software package;
c) using said delta-update package for creating said updated installation-software package out of said old installation-software package;
d) using said updated installation-software package for installing said new version of said hearing-device fitting-software package on said computer system.

11. Method for manufacturing a software package for installing a new version of a hearing-device fitting-software package on a computer system, comprising the step of
k) creating—for at least one of N older versions of said hearing-device fitting-software package, with N≧1—a delta-update package, which is a software package for creating an updated installation-software package out of an old installation-software package, which old installation-software package is an installation software-package for installing said old version of said hearing-device fitting-software package, and wherein said updated installation-software package is an installation software-package for installing said new version of said hearing-device fitting-software package.

12. Computer program product comprising program code for causing a computer to perform the steps of
c′) creating an updated installation-software package out of an old installation-software package, which old installation-software package is an installation software-package for installing said old version of a hearing-device fitting-software package, and wherein said updated installation-software package is an installation software-package for installing said new version of said hearing-device fitting-software package.

13. Computer program product according to claim 12, wherein said program code is adapted to causing said computer to perform in addition the step of
d′) using said updated installation-software package for installing said new version of said hearing-device fitting-software package on a computer system.

14. Computer-readable storage medium comprising program code for causing a computer to perform the step of
c′) creating an updated installation-software package out of an old installation-software package, which old installation-software package is an installation software-package for installing said old version of a hearing-device fitting-software package, and wherein said updated installation-software package is an installation software-package for installing said new version of said hearing-device fitting-software package.

15. The computer-readable storage medium according to claim 14, wherein said program code is adapted to causing said computer to perform in addition the step of
d′) using said updated installation-software package for installing said new version of said hearing-device fitting-software package on a computer system.
